(19) United States
(12) Patent Application Publication
(10) Pub. No.: US 2025/0238016 A1
(43) Pub. Date: Jul. 24, 2025

(54) AUTOMATION AND MOTION CONTROL SYSTEM FOR PROVIDING MOTION PATHS FOR THEATRICAL OBJECTS

(71) Applicant: TAIT TOWERS MANUFACTURING, LLC, Lititz, PA (US)

(72) Inventor: Aaron Edwin IRELAND, Bath (GB)

(21) Appl. No.: 18/416,316

(22) Filed: Jan. 18, 2024

(51) Int. Cl. G05B 19/4155

(52) U.S. Cl. CPC G05B 19/4155; G05B 2219/34216

(57) ABSTRACT

An automation and motion control system and method to control a plurality of theatrical objects. The method includes providing a plurality of axis nodes and an operator console node in communication with each other over a real time network. A first motion path is defined for the theatrical object. One or more object movement parameters are provided to a sunstone tool. An adjusted second motion path for the theatrical object is defined with the sunstone tool in response to the one or more object movement parameters and the first motion path. A live motion path is selected, and motion is provided to the devices with the control instructions corresponding to the live motion path to move the theatrical object along the live motion path.

### FIELD OF THE INVENTION

The present disclosure is generally directed to methods and systems relating to control systems, particularly for control systems for providing motion paths for theatrical objects.

### BACKGROUND OF THE INVENTION

In the entertainment industry, to provide a realistic atmosphere for a theatrical production, theatrical objects or components can be moved or controlled by an automation and motion control system during (and between) scenes on a stage or during some other live or scripted entertainment. Automation of the movement and control of the theatrical objects or components is desirable for safety, predictability, efficiency, and economics. Prior theatrical object movement and control systems provided for the control and movement of the theatrical objects or components under the control of a central computer or microprocessor. The prior movement and control systems controlled a large number of devices using lists of sequential actions or instructions that were executed by the central computer. For example, the motorized movement of the objects could be provided by drive motors, which may or may not use variable speed drives, coupled to the central computer, possibly through one or more intermediate controllers. The prior theatrical object movement and control systems used a hierarchical order with a definite progression from operator controls to data network to control device to field device.

One particularly challenging element of live theatrical productions is providing motion paths for theatrical objects, such as performer flying and/or automated object motion. Control is particularly difficult when real-time adjustments need to be made to a particular flight path or movement path. For example, real-time adjustments may be required to maintain safety or to maintain a quality theatrical production. Current systems lack the ability to make real-time adjustments to flight paths and lacks predictive capabilities. For example, current systems do not consider potential emergency stops or failure scenarios based on the current flight system dynamics.

Known systems possess critical limitations for use in modern live entertainment systems. One notable drawback is their inadequacy on informing users about the dynamic forces exerted on the payload or performer during flight, thus lacking comprehensive insights into the impact on safety and comfort. Additionally, known systems also lack the capability to design optimal flight paths that minimize reactive forces imposed on the payload or performer.

What is needed is an automation and motion control system that provides the ability to display and implement motion paths in real-time that more accurately reflect real-life conditions that does not suffer from the drawbacks of the prior art. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

The application generally relates to an automation and motion control system. The application relates more specifically to a sunstone tool that provides an ability to display and implement motion paths of theatrical objects within an automation and motion control system. The sunstone tool allows the display and implementation of motions paths in real-time and a reflection of conditions present within the system.

One embodiment of the present disclosure is directed to a method to control motion of a theatrical object. The method includes providing a plurality of axis nodes and an operator console node in communication with each other over a real time network. Each axis node of the plurality of axis nodes corresponds to at least one device for control of motion of a theatrical object. Each axis node of the plurality of nodes and the operator console node has a microprocessor and a memory device, the operator console node further includes a sunstone tool and a space device. A first motion path is defined for the theatrical object with a first operator interface of the space device. One or more object movement parameters are provided to the sunstone tool. An adjusted second motion path for the theatrical object is defined with the sunstone tool in response to the one or more object movement parameters and the first motion path. The first motion path and the adjusted second motion path for the theatrical object is displayed with a display device to an operator. A live motion path is selected from the group consisting of the first motion path, the adjusted second motion path and combinations thereof. In one embodiment, the adjusted second motion path is within a displayed safe operational cloud zone provided by the sunstone tool. The live motion path for the theatrical object is processed and the relationship between the theatrical object and the plurality of devices is determined to generate one or more control instructions to control operation of the devices to move the theatrical object along the live motion path. Motion is provided to the devices with the control instructions to move the theatrical object along the live motion path.

Another embodiment of the present disclosure includes an automation and motion control system to control motion of a theatrical object. The control system includes a plurality of axis nodes and an operator console node in communication with each other over a real time network. The axis node corresponds to a device for control of motion of a theatrical object. The axis node provides control to the device to, in combination with additional axis nodes of the plurality of nodes, provide motion to the theatrical object. Each axis node of the plurality of nodes and the operator console node includes a microprocessor and a memory device. The operator console node further includes a sunstone tool and a space device. The space device includes a display device enabled to display a first motion path and an adjusted second motion path for the theatrical object in the predefined space, a first operator interface enabled to define the first motion path for the theatrical object in the predefined space, and a second operator interface enabled to select a live motion path from the group consisting of the first motion path, the adjusted second motion path and combinations thereof. In one embodiment, the adjusted second motion path is within a displayed safe operational cloud zone provided by the sunstone tool. The sunstone tool is in communication with the space device. The sunstone tool is configured to receive one or more object movement parameters and the first motion path to calculate the adjusted second motion path in response to the one or more object movement parameters and the first motion path.

Other features and advantages of the present invention will be apparent from the following more detailed description of the preferred embodiment, taken in conjunction with the accompanying drawings which illustrate, by way of example, the principles of the invention.

### BRIEF DESCRIPTION OF DRAWINGS

FIG. 1 schematically shows an embodiment of an automation and motion control system.

FIG. 2 schematically shows an alternate embodiment of an automation and motion control system.

FIG. 3 schematically shows an embodiment of a node from the automation and motion control system according to the present disclosure.

FIG. 4 schematically shows an embodiment of an operator console node from the automation and motion control system according to the present disclosure.

FIG. 5 illustrates a data processing system according to an embodiment of the present disclosure.

FIG. 6 schematically shows an embodiment of a sub- or co-process of a node process according to an embodiment of the present disclosure.

FIG. 7 shows a diagram of an example of motion control for a theatrical object according to an embodiment of the present disclosure.

FIG. 8 shows an example of a first motion path generated by a space device shown on a display according to an embodiment of the present disclosure.

FIG. 9 shows an example of a first motion path generated by a space device and an adjusted second motion path generated by a sunstone tool shown on a display according to an embodiment of the present disclosure.

FIG. 10 shows an example of a position error for a theatrical element suspended from towers generated by the sunstone tool according to an embodiment of the present disclosure.

FIG. 11 shows a graph illustrating a cloud zone for a theatrical element generated by a sunstone tool shown on a display according to an embodiment of the present disclosure.

FIG. 12 shows a perspective view and a top view of the graph of FIG. 11 illustrating a cloud zone for a theatrical element generated by a sunstone tool shown on a display according to an embodiment of the present disclosure.

FIG. 13A shows a position error in the motion path for a theatrical element generated by a sunstone tool shown on a display according to an embodiment of the present disclosure.

FIG. 13B shows a position error in the motion path for a theatrical element generated by a sunstone tool shown on a display according to an embodiment of the present disclosure.

FIG. 13C shows a position error in the motion path for a theatrical element generated by a sunstone tool shown on a display according to an embodiment of the present disclosure.

FIG. 14 shows a series of graphs illustrating the positioning of a theatrical element on a motion path generated by a sunstone tool shown on a display showing a first position corresponding to a first motion path and a second position corresponding to an adjusted second motion path according to an embodiment of the present disclosure.

FIG. 15 shows a graph illustrating flexible towers that provide deformation conditions that are parameters utilized by the sunstone tool according to an embodiment of the present disclosure.

FIG. 16 shows an exemplary display shown to an operator by the sunstone tool showing a first motion path and an adjusted second motion path including a cloud zone generated with the sunstone tool according to an embodiment of the present disclosure.

Wherever possible, the same reference numbers will be used throughout the drawings to represent the same parts.

### DETAILED DESCRIPTION OF THE INVENTION

The system and method according to the present disclosure includes a sunstone tool which provides a motion and control system having increased safety for live entertainment events that include flying or other motion of theatrical objects, such as flying performers. The sunstone tool empowers live performances with the ability to make real-time adjustments to the flight path. In addition, the sunstone tool offers comprehensive predictive capabilities, encompassing all potential emergency stops or failure scenarios based on the current flight system dynamics. By constantly monitoring the system's flight dynamics, the sunstone tool delivers instant feedback and recommendations to operators or technicians, enabling them to promptly make necessary adjustments and ensure safety throughout the performance. Safety is a primary priority in the events industry, and the use of system and method according to the present disclosure assist in ensuring that automated motion, such as performer flying, is safe and reliable. The system and method according to the present disclosure utilizing the sunstone tool can simulate various failure scenarios and identify potential hazards or risks in advance, allowing for better preparation and adjustment of the planned performance. For example, if the automation system detects a potential safety concern during the flight, such as excessive cable or line tension, high g-forces, or potential collisions, the system can provide immediate alerts and warnings to the operator. These alerts may be displayed to assist the operator in making informed decisions and take corrective actions to ensure the safety of the performer or object being flown while still maintaining the positional timing and accuracy which is critical in camera-based flight paths. The alerting of these conditions to the operator and the ability to alter motion paths can help reduce the risk of accidents and injuries, which can result in significant cost savings for the organization. The cost of insurance and legal fees associated with performer flying is a large risk that can be significantly mitigated with a thorough dynamic analysis of the performance and the ability to alter motion paths, as needed. The incorporation of the system and method according to the present disclosure into existing control logic in can provide a direct correspondence between the simulation and the real-world, reducing the risk of accidents, injuries, and equipment damage. The incorporation into control logic can result in cost savings for the organization by reducing the need for repairs or replacement of equipment. Additionally, this can improve the reliability and consistency of performer flying events, enhancing the organization's reputation, and attracting more clients in the long term. By using the simulation functionality of the system and method according to the present disclosure, including the display of the predicted motion path, costs of physical testing and prototyping, which can be time-consuming and expensive, can be reduced. This simulation functionality can result in significant cost savings for the organization by avoiding the need for unnecessary physical testing. The dynamic analysis capability of the simulation utilized by the system and method according to the present disclosure can allow producers of live entertainment shows to push the envelope in performer flying and offer never-before-seen flying capabilities. The system and method according to the present disclosure stands apart from known systems due to its advanced analytical capabilities, precisely assessing flight dynamics and providing in-depth insights into the forces affecting payloads and performers that can then be acted upon by a user or through an automated process. Furthermore, the system and method according to the present disclosure excels in creating optimized flight paths that prioritize safety, comfort, and efficiency, representing a notable advancement over preceding systems in the realm of 3D performer flying. Another advantage of the method and system according to the present disclosure is the ability for compensation of the flight path depending on the venue the flying system is used in. For instance, if a performance occurred in in a first venue one night and the next night in a second venue, substantially different than the first venue, the system according to the present disclosure would be able to preserve the artistic intent of the flight path while altering the flight path dynamics for this new venue. Without the system and method according to the present disclosure, each venue is bespoke and may lead to more dangerous flight dynamic situations or costly testing. The ability to alter the boundary conditions of the flight system while still maintaining performance is not found in known systems.

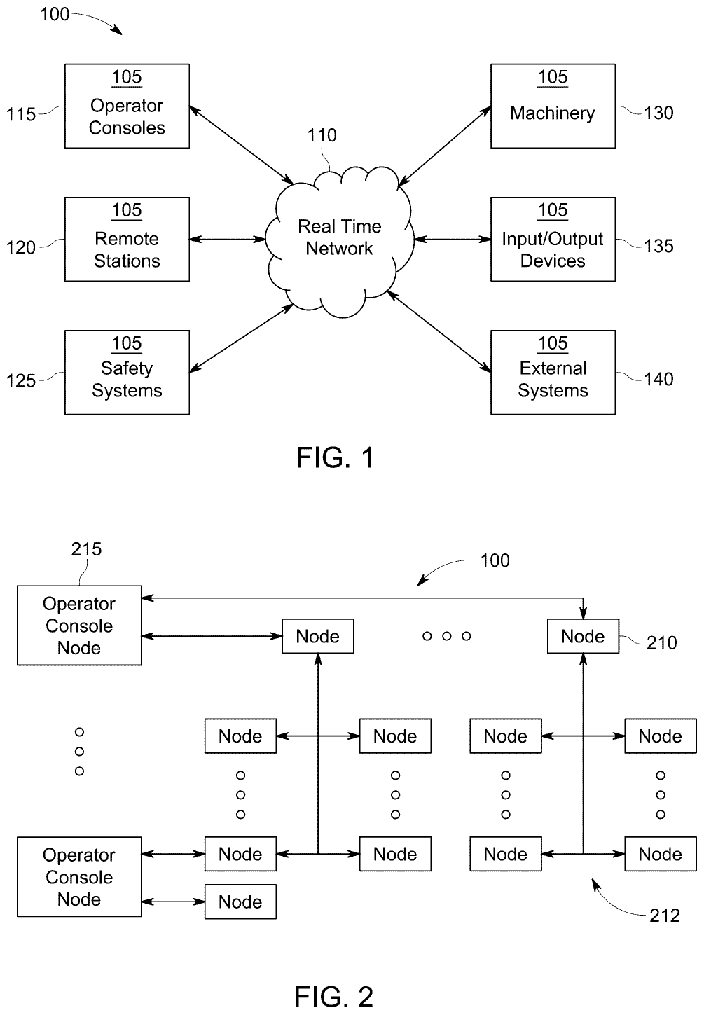

FIG. 1 shows an exemplary embodiment of the automation and motion control system 100 according to the present disclosure. The automation and control system 100 can include a real time network 110 interconnecting devices 105 including operator consoles 115, remote stations 120, safety systems 125, machinery 130, input/output devices 135 and external systems 140. In one exemplary embodiment, safety systems 125 can include emergency stop (e-stop) systems; machinery 130 can include lifts, chain hoists, winches, elevators, carousels, turntables, hydraulic systems, pneumatic systems, multi-axis systems, linear motion systems (e.g., deck tracks and line sets), audio devices, lighting devices, and/or video devices; input/output devices 135 can include incremental encoders, absolute encoders, variable voltage feedback devices, resistance feedback devices, tachometers and/or load cells; and external systems 140 can include show control systems, industrial protocols and third party software interfaces including 0-10 V (volt) systems, MATLAB, Modbus systems, Profibus systems, ArtNet systems, BMS (Building Management System) systems, EtherCat systems, DMX systems, SMPTE (Society of Motion Picture and Television Engineers) systems, VITC systems, MIDI (Musical Instrument Digital Interface) systems, MANET (Mobile Ad hoc NETwork) systems, K-Bus systems, Serial systems (including RS 485 and RS 232), Ethernet systems, TCP/IP (Transmission Control Protocol/Internet Protocol) systems, UDP (User Datagram Protocol) systems, ControlNet systems, DeviceNet systems, RS 232 systems, RS 45 systems, CAN bus (Controller Area Network bus) systems, Maya systems, Lightwave systems, Catalyst systems, 3ds Max, 3D Studio Max systems, Unreal Engine, Audinate Dante, or Disguise Media servers and/or a custom designed system.

FIG. 2 shows an embodiment of the automation and motion control system 100 according to the present disclosure. The automation and motion control system 100 shown in FIG. 2 can be formed from the interconnection of axis nodes 210. Each axis node 210 may correspond to a specific device 105 (or group of devices 105) from remote stations 120, safety systems 125, machinery 130, input/output devices 135 and external systems 140. By “correspond to”, “corresponding to”, and grammatical variations thereof, it is meant that the axis node 210 includes a microprocessor and associated software/firmware that controls or otherwise interacts with the device 105 in a manner that provides control or information exchange. Devices 105 for use with the automation and control system 100 according to the present disclosure may, for example, correspond to one or more of a winch, a lift, a motor, a pneumatic/hydraulic cylinder, a linear actuator, a trolley, a dolly, a cane, a jib, a boom, and a gimbal. An operator console node 215 can be a specific device 105 from operator consoles 115 and can enable an operator to interact with the automation and control system 100, i.e., to send data and instructions to the automation and control system 100 and to receive data and information from the automation and control system 100. The operator console node 215 is similar to the other axis nodes 210 except that the operator console node 215 can include a graphical user interface (GUI) or human-machine interface (HMI) to enable the operator to interact with the automation and control system 100. In one exemplary embodiment, the operator console node 215 can be a Windows® or other known computer suitable for motion control. In certain embodiments of the present disclosure, the operator console node 215 includes a display that provides a visual representation of the devices and their control features, through the graphical user interface (GUI) or human-machine interface (HMI).

In one exemplary embodiment, the operator(s) can make inputs into the system at operator console nodes 215 using one or more input devices 105, e.g., a pointing device such as a mouse, a keyboard, a panel of buttons, touch screen or other similar devices. As shown in FIG. 2, axis nodes 210 and operator console nodes 215 are interconnected with each other. Thus, any node 210 or operator console node 215 can communicate, i.e., send and receive data and/or instructions, with any other node 210 or operator console node 215 in the automation and control system 100. In one exemplary embodiment, a group of axis nodes 210 can be arranged or configured into a network 212 that interconnects the axis nodes 210 in the group and provides a reduced number of connections with the other nodes 210 or operator console node 215. In another exemplary embodiment, nodes 210, operator console node 215 and/or node networks 212 can be interconnected in a star, daisy chain, ring, mesh, daisy chain loop, token ring, or token star arrangement or in combinations of those arrangements. In a further exemplary embodiment, the automation and control system 100 can be formed from more or less nodes 210, operator console node 215 and/or node networks 212 than those shown in FIG. 2.

In one exemplary embodiment, each node 210 or operator console node 215 can be independently operated and self-aware, and can also be aware of at least one other node 210, operator console node 215. In other words, each node 210 or operator console node 215 can be aware that at least one other node 210 or operator console node 215 is active or inactive (e.g., online or offline).

In another exemplary embodiment, each node 210 or operator console node 215 is independently operated using decentralized processing, thereby allowing the automation and control system 100 to remain operational even if a node 210 or operator console node 215 may fail because the other operational nodes still have access to the operational data of the nodes. Each node 210 or operator console node 215 can be a current connection into the automation and control system 100, and can have multiple socket connections into the network, each providing node communications into the automation and control system 100 through the corresponding node 210 or operator console node 215. As such, as each individual node 210 or operator console node 215 is taken “offline,” the remaining nodes 210 or operator console node 215 can continue operating and load share. In a further exemplary embodiment, the automation and control system 100 can provide the operational data for each node 210 to every other node 210 or operator console node 215 all the time, regardless of how each node 210 or operator console node 215 is related to each other node 210 or operator console node 215.

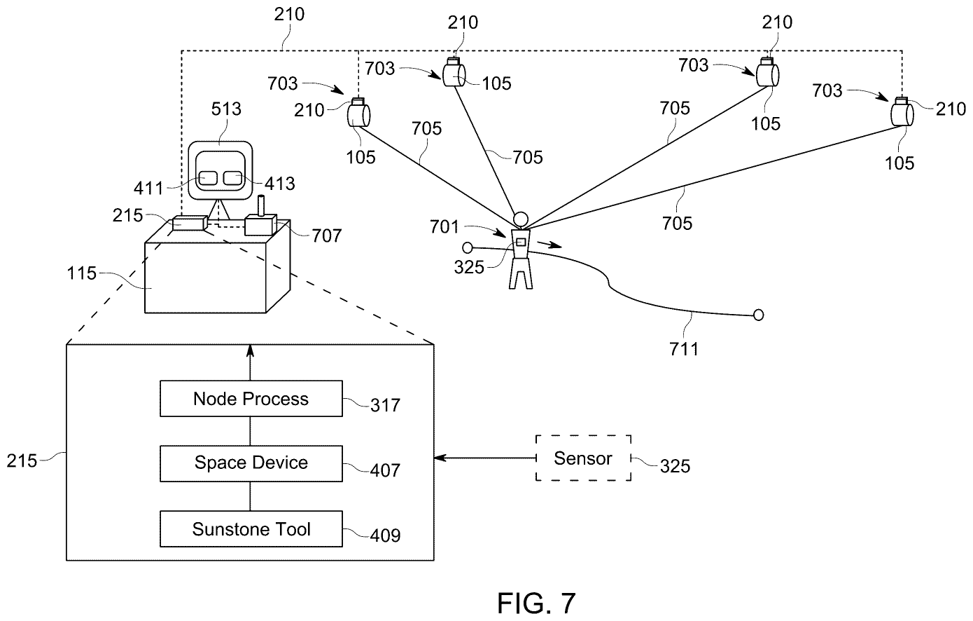

In one exemplary embodiment, axis node 210 may correspond to an “axis” device 105 (see FIG. 7). The “axis” device 105 can be used represent a piece of machinery that moves an object. In another embodiment, the “axis” device 105 may be an Input/Output device 135 whereby boolean and numeric values may be controlled. For example, a node 210 may have an Input/Output device 135 boolean controller to energize or denergize a relay, command a function in a fixture to turn on/off (e.g., camera ND filter on/off, camera record start/stop, lighting fixture diffuser on/off etc.), or numeric controller to command an 0-10V output, 4.20 mA output, or some digitally manifest numeric signal (e.g., a lighting fixture dimmer 0-100%, a camera white balance setting, etc.). The automation and control system 100 can be used with a variety of different axis devices 105 that correspond to the controllers for the end machines that make theatrical objects move. Examples of axis devices 105 may include engines, motors (AC/DC), servos, hydraulic movers, and pneumatic movers. Examples of machinery that may include motion include, but are not limited to lifts, chain hoists, winches, elevators, carousels, turntables, hydraulic systems, pneumatic systems, multi-axis systems, and linear motion systems (e.g., deck tracks and line sets).

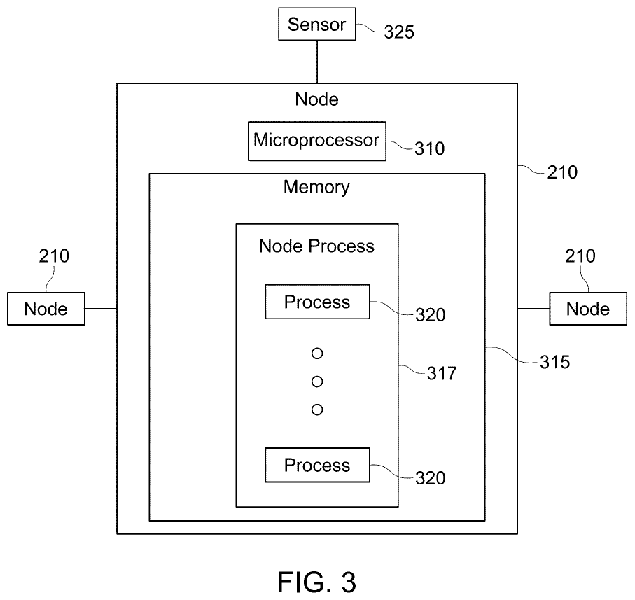

FIG. 3 schematically shows an exemplary embodiment of an axis node 210. Each axis node 210 includes a microprocessor 310 and a memory device 315. The memory device 315 can include or store a main or node process 317 that can include one or more sub- or co-processes 320 that are executable by the microprocessor 310. The main or node process 317 provides the networking and hardware interfacing to enable the sub- or co-processes to operate.

The microprocessor 310 in an axis node 210 can operate independently of the other microprocessors 310 in other axis nodes 210. The independent microprocessor 310 enables each axis node 210 in the automation and control system 100 to operate or function as a “stand-alone” device 105 or as a part of a larger network. In one exemplary embodiment, when the axis nodes 210 are operating or functioning as part of a network, the axis nodes 210 can exchange information, data and computing power in real time without recognizing boundaries between the microprocessors 310 to enable the automation and control system 100 to operate as a “single computer.” In another embodiment, each axis node 210 may use an embedded motion controller.

Axis node 210 may include sensors 325 that may gather real-time or dynamic data. Sensors 325 may be any data collecting device that is capable of providing data useful for determining a location, state or property of a device 105 corresponding to axis node 210. Some examples of dynamic or real-time information that can be measured with sensors 325 can include temperature, current, load or weight (load cell), angle, g-force or acceleration (accelerometer), direction of movement, or speed of movement. Suitable sensors 325 may include tertiary real time positioning systems (e.g., optical tracking, such as BlackTrax™, GPS/GNSS, Bluetooth Beacons, LIDAR systems, etc.) that provide moving target coordinates for use by axis node 210. Other suitable sensors 325 may include, but are not limited to inertia sensor (e.g., accelerometers, gyro-sensors, etc.), global positioning system (GPS) sensors, voltage meters, temperature sensors, contact or non-contact displacement sensors (e.g., linear variable differential transformers (LVDT), differential variable reluctance transducers (DVRT)), slide potentiometers, radar sensors, LiDAR sensors, magnetic sensing systems, optical or infrared sensing systems, radio frequency identification (RFID) sensors or any combination thereof.

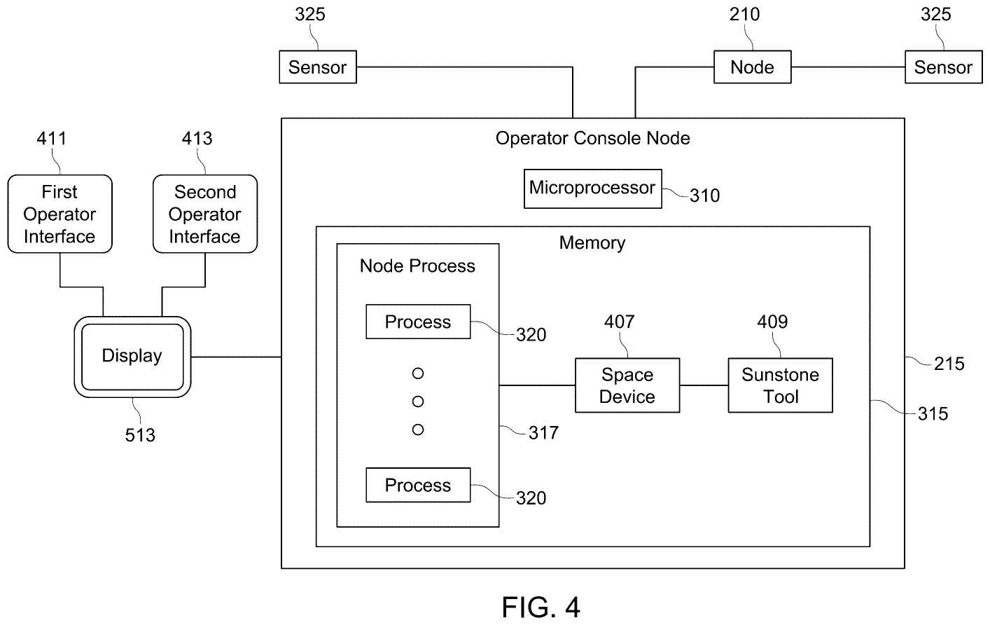

FIG. 4 schematically shows an exemplary embodiment of an operator console node 215. Each operator console node 215, like axis node 210, includes a microprocessor 310 and a memory device 315. The memory device 315 can include or store a main or node process 317 that can include one or more sub- or co-processes 320 that are executable by the microprocessor 310. The main or node process 317 provides the networking and hardware interfacing to enable the sub- or co-processes to operate.

The microprocessor 310 in an operator console node 215 can operate independently of the other microprocessors 310 in other an operator console node 215. The independent microprocessor 310 enables each operator console node 215 in the automation and control system 100 to operate or function as a “stand-alone” device 105 or as a part of a larger network. In one exemplary embodiment, when the operator console nodes 215 is operating or functioning as part of a network 212, the operator console nodes 215 can exchange information, data and computing power in real time without recognizing boundaries between the microprocessors 310 to enable the automation and control system 100 to operate as a “single computer.” In another embodiment, each axis node 210 may use an embedded motion controller.

Like axis node 210, operator console node 215 may include sensor 325. Sensor 325 provides information to operator console node 215 including real-time or dynamic data. Sensors 325 may be any data collecting device that is capable of providing data useful for determining a location, state or property of a device 105, including any of the sensors 325 shown and described above with respect to axis node 210.

FIG. 4 shows a space control sub- or co-process (“space device 407”) that can be implemented into a node 210 or operator console node 215 to control and/or simulate one or more three dimensional (3-D) motion systems in a predefined space. In addition, the space device 407 can also display the movement or operation of the 3-D motion system(s) in the predefined space while in operation. The space device 407 enables a user or operator to work with sets of interrelated axis nodes or devices (machines), where arguments or cues for the axis nodes 210 or devices 105 are executed by “player processes.” Each argument or cue can have lists of motion groups or routines that define what list each motion group is in, which sub-list the motion group is in, and which cue the motion group is in. Constructs can be programmed to incorporate, integrate and interrelate multiple machines/axis nodes or devices 105 to a single point of control. In one embodiment, the single point of control can correspond to the center of mass or center of gravity of the object to be moved by the 3-D motion system. In another embodiment, the single point of control can correspond to another point separate from the center of mass or center of gravity. For example, the space device 407 may provide a display of the multiple machines/axis nodes or devices on display 513 and may show a first motion path for the theatrical object. The space device 407 permits an operator to control and manipulate a single point in a three-dimensional space via a first operator interface 411 so as to control various movement aspects of each of the machines/axes in that single point of control. The first operator interface 411 may include either automatic or manual inputs into the system, for example, automatic inputs may include calculated, reactive or preprogrammed motion paths and manual inputs may use one or more input devices, e.g., a pointing device such as a mouse, a keyboard, a panel of buttons, touch screen or other similar devices. In one exemplary embodiment, the motion of the machinery can be displayed via a 3-D graphic model on display 513 to enable an operator to view the position of all equipment or axes in motion (even if there is no line of sight) by adjusting viewing angles in the 3-D graphic model.

A time parameter can be assigned by an operator to correlate particular positions and/or orientations to particular instances in time. When time parameters are defined for a particular path, the acceleration, deceleration and velocity parameters between positions and/or orientations can be automatically calculated. In another embodiment, a beginning and ending time can be defined and the remaining time instances can be calculated for the corresponding positions and/or orientations in the path. Further, the time instances, once defined can be automatically scaled if a longer or shorter overall time is desired.

In one embodiment, once the motion path or profile for the object is defined, the path or profile can be provided to the corresponding axis nodes 210 or devices 105 for simulation or execution of the specific commands (once calculated) by the axis nodes 210 or devices 105. By having the axis nodes 210 or devices 105 simulate or execute the specific commands required by the path and then displaying the path in the space device 407, the path can be modified in real-time by adjusting the path displayed in the space device 407. In another embodiment, the calculation of the specific commands to be executed by the axis nodes 210 or devices 105 can be precalculated and provided to the nodes 210 or devices 105. If the specific commands to be executed by the nodes 210 or devices 105 are pre-calculated, the path cannot be modified in real-time.

The space device 407 can permit an operator to monitor and display simulations of automation or motion routines (before sending the routines to the nodes 210 or devices 105 for execution) or, after sending the motion routine to the nodes 210 or devices 105 for execution, i.e., to generate operational commands, to monitor and display the actual motion of the system. When simulating the automation or motion routines, the simulation can occur within the space device 407 or the associated axis nodes 210 or devices 105 can simulate the automation or motion routines and send the resultant data from the simulation back to the space device 407. If the axis node 210 or devices 105 are executing the automation or motion routine, the axis nodes 210 or devices 105 can send their resultant data from executing the routine back to the space device 407. In one embodiment, the automation or motion routines can be written and tested virtually to monitor the 3-D motion system and to view the 3-D motion system from all angles. If the automation or motion routine is acceptable, the routine can be switched from simulation at the axis nodes 210 or devices 105 to execution at the axis nodes 210 or devices 105 via first operator interface 411 for subsequent playback and inclusion in the performance cue list.

In the space device 407, there can be static elements analyzed, i.e., elements that do not move in the predefined space, and motion elements, i.e., elements that move or cause movement in the predefined space. The user or operator can define the location of static elements, e.g., walls, columns, fixed scenery items, etc., in the predefined space via first operator interface 411. Once the static elements are defined, the location of the static elements can be used for different purposes including collision detection with motion elements. The motion elements can be used in conjunction with the motion path or profile to create and/or implement the specific actions of the components needed to enable the object to travel the path defined by the motion profile. The motion elements can include the object to be moved, engines, which can correspond to a 3D model of an axis device 105, laces, which correspond to the items used to connect the engines to the object to be moved, lace attachment points on the object to be moved.

In another exemplary embodiment, the space device 407 can use a Stewart Platform orientation to support the positional and orientational movements of the object. The Stewart Platform orientation can provide for the placement of the object in the space. The placement of the object can include the location of the object (the 3D coordinates (X, Y, Z) where the object center is located) and the orientation of the object (how the object's local coordinate system is oriented with respect to parent coordinate system). The X, Y, Z coordinates and the alpha, beta, gamma coordinates entered into a motion profile can be converted into Stewart Platform coordinates.

To define a Stewart Platform orientation, a two-component value is used that includes tilt and rotation. The tilt can be a two-component value that includes longitude and latitude. For convenience, the components of the Stewart Platform orientation can be combined into a three-component 3D point format (longitude, latitude, rotation), which is used to describe momentary object orientation and define profiles. The coordinate axes' characters used for orientation are “L” for longitude, “A” for latitude and “R” for rotation (similar to X, Y, Z that describe object's position).

The space device 407 can also incorporate collision detection features to prevent an object from colliding with static elements or another dynamic element, if present. In one embodiment, the collision detection feature can be implemented by defining an “envelope” around each object and then determining if the “envelopes” for the objects intersect or overlap during a simulation of the motion profile(s) for the objects. If an intersection or overlap occurs during the simulation, the operator can be notified of the possibility of a collision if the motion profiles were to be executed and can adjust the motion profile as appropriate. By setting the size of the “envelopes” surrounding the objects, the operator can control the frequency of possible collisions. The use of larger “envelopes” can provide more frequent possible collisions and the use of smaller “envelopes” provides less frequent possible collisions. However, the use of smaller “envelopes” may result in actual collisions during execution if the components have larger error margins than accounted by the “envelope.” In one embodiment, the “envelope” can be defined as sphere around the object, while in another embodiment, the “envelope” can be a cuboid or prism. In other embodiments, any suitable geometric shape can be used to define the “envelope” for an object.

In addition to the space device 407, within the memory 315, the operator console node 215 includes a sunstone tool 409. The sunstone tool 409 is in communication with the space device 407 to provide control to the at least one device 105 and associated theatrical objects. The sunstone tool 409 has the ability to constantly monitors the system's flight dynamics, the sunstone tool 409, and when utilized with the space device 407, delivers instant feedback and recommendations to operators or technicians, enabling them to promptly make necessary adjustments and ensure safety throughout the performance. The sunstone tool 409 also is capable of acting as a safeguard by automatically “course correcting” to mitigate dangerous inputs from the operator. The operator console node 215 includes a second operator interface 413 for providing an input to the sunstone tool 409, which provides input to the system to provide ultimate motion control to the system. The second operator interface 413, like the first operator interface 411 may include either automatic or manual inputs into the system, for example, automatic inputs may include calculated, reactive or preprogrammed motion paths and manual inputs may use one or more input devices, e.g., a pointing device such as a mouse, a keyboard, a panel of buttons, touch screen or other similar devices. In certain embodiments, the physical interface for the second operator interface 413 may be the same as the first operator interface 411. The “envelopes” created by sunstone tool 409, which may be represented, for example, by cloud zones, are based on the dynamic response of the flying system due to not only mechanical failures, but also control related failures. Therefore, the collision detection provided by sunstone tool 409 reduces the error margins significantly. For example, inputs for either the first operator interface 411 and the second operator interface 413 may be on the same touch screen or the same input panel or device 105. The second operator interface 413 may include various input sources, including automatic systems, such as preprogrammed or reactive flight paths, as well as manual inputs, such as from joysticks or manual control mechanisms. Additionally, the sunstone tool 409 leverages sophisticated analysis and simulation that considers the system's physics and control logic to proactively course-correct the flight and maintain a safe state, effectively preventing performers from encountering hazardous situations. The sunstone tool 409 utilizes one or more object movement parameters and the first motion path to provide the adjusted second motion path. That is, the object movement parameter is included in the calculation made by the sunstone tool 409 with respect to the first motion path. The object movement parameters are parameters that provide an accurate real-life and real-time prediction of positioning of theatrical objects within automation and control system 100. For example, while not so limited, the object movement parameters may include position of the theatrical object, velocity of the theatrical object, acceleration of the theatrical object, cable tension, g-forces of the theatrical object, venue dimensions, position of obstacles and combinations thereof. Object movement parameters are directly incorporated into the calculation performed by sunstone tool 409, and one such example is in the calculation of the cable tension. This cable tension calculation can be for either a current or future state of the system. A 3D flying system is typically an indeterminant system, therefore the calculation of cable tension is not a trivial task and requires a solution to a piecewise series of differential equations, often only possible through the use of numerical methods. Through object movement parameters includes such as position, velocity, acceleration, cable material properties, and venue dimensions, an interrelated calculation can be performed that solves the time dependent dynamic model that is able to calculate the tension in each given cable. This calculation requires consideration of catenary action of the cables, their associated stiffness and dampening effects, and the commanded state of the automation and control system to the flown payload, or in the case of a mechanical failure, the brake application may also be necessary.

This course correction through the sunstone tool 409 is a process that selects the most efficient, smooth, and safest trajectory for the flight path, prioritizing the safety and comfort of the performer while minimizing unnecessary risks and inputs the course correction into the system via second operator interface 413. This course correction can consider a prioritization of one variable over another, for instance the prioritization of being at a certain location in time over the specific artistic trajectory originally desired for the first fight path. In one embodiment, the sunstone tool 409 may use multi-objective optimization to find flight paths balancing visual impact, safety, and comfort of the performer among others. By evaluating different paths using Pareto dominance, the sunstone tool 409 identifies options that excel in one aspect without significantly compromising others. The sunstone tool 409 then proposes an adjusted second flight path that the operator can then choose, or cycle through the next best-suited trajectory from these adjusted paths within the operational cloud zone, ensuring a safe and visually captivating experience for both performers and the audience. By analyzing real-time factors such as position, velocity, acceleration, cable tension, g-forces, and venue dimensions or obstacles, the tool provides valuable insights to optimize the flight path, elevating the visual aesthetic and captivating nature of the performance while prioritizing the safety of the performer.

In one embodiment, the sunstone tool 409 utilizes a fourth-order Runge-Kutta numerical method to solve an initial value problem with differential equations combined with the unique control logic from the automation and control system 100. By incorporating the commanded winch motion profiles from the space device 407, it accurately translates them into a realistic flight path based on the underlying physics of the flight system, utilizing at least one object movement parameter. The space device 407 accommodates various object movement parameters, for example, different cable material properties (such as damping and viscoelastic effects), linear or non-linear brake torque application, safety function response time (SFRT), Cat1 declarations, Cat0 decelerations, torque limitations on the motor, and other similar parameters.

In one embodiment, the sunstone tool 409 calculates metrics such as the time history of maximum line tension, the g-forces experienced by the performer/payload, and the time history of overtravel. Moreover, it simulates stop/failure scenarios at every millisecond along the flight path, providing a comprehensive understanding of potential failure implications that would be impossible to achieve through physical testing alone. This capability enables the identification of dangerous locations within the flight envelope, ensuring utmost safety and reliability during performer flying events.

The space device 407 visualizes or otherwise displays the flight path and related parameters in real-time, on display 513 providing a graphical representation of the current position, trajectory, and other relevant data using the physics of the flight system. This visual feedback on display 513 allows the operator to have a clear understanding of the flight dynamics and make adjustments accordingly. In one embodiment, the space device 407 can analyze and quantify the overtravel of the performer during the flight path during an emergency stop or failure event. The space device 407 calculates and provides information on the extent to which the performer deviates from the intended flight path, helping to optimize the system's parameters and control logic to minimize overtravel and avoid obstacles. This improves the precision and control of the flight path, ensuring that the performer stays within the designated performance area.

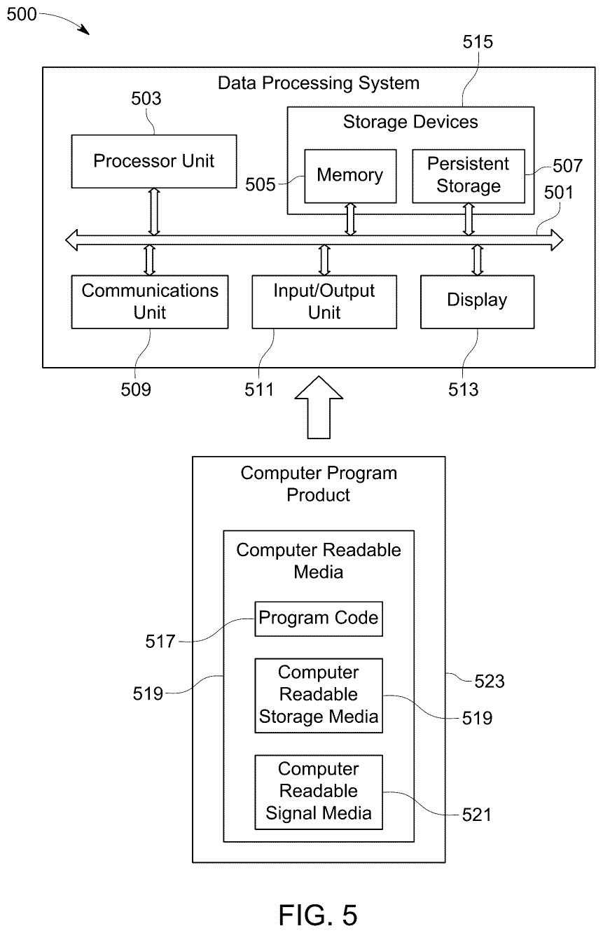

FIG. 5 shows an exemplary illustration of a data processing system 500 suitable for use as components of the system, including, but not limited to axis node 210 and operator console node 215. In this illustrative example, data processing system 500 may include communications fabric 501, which provides communications between processor unit 503, memory 505, persistent storage 507, communications unit 509, input/output (I/O) unit 511 and display 513. While FIG. 5 shows various elements including processor unit 503, memory 505, persistent storage 507, communications unit 509, input/output (I/O) unit 511, and display 513, some or all of the elements may be present for particular configurations of axis node 210 and/or operator console node 215. For example, certain nodes 210 may not utilize input/output (I/O) unit 511 and display 513. The utilization or particular components is dependent upon the functionality needed for a particular axis node 210 or operator console node 215.

Processor unit 503 may be one or a number of processors, a multi-processor core, or some other type of processor, depending on the particular implementation. A number, as used herein with reference to an item, means one or more items. Further, processor unit 503 may be implemented using a number of heterogeneous processor systems in which a main processor is present with secondary processors on a single chip. As another illustrative example, processor unit 503 may be a symmetric multi-processor system containing multiple processors of the same type.

Memory 505 and persistent storage 507 are examples of storage devices 515. A storage device 515 is any piece of hardware that is capable of storing information, such as, for example, without limitation, data, program code in functional form, and/or other suitable information either on a temporary basis and/or a permanent basis. Storage devices 515 may also be referred to as computer readable storage devices in these examples. Memory 505, in these examples, may be, for example, a random access memory or any other suitable volatile or non-volatile storage device. Persistent storage 507 may take various forms, depending on the particular implementation.

For example, persistent storage 507 may contain one or more components or devices 105. For example, persistent storage 507 may be a hard drive, a flash memory, a rewritable optical disk, a rewritable magnetic tape, or some combination of the above. The media used by persistent storage 507 also may be removable. For example, a removable hard drive may be used for persistent storage 507.

Communications unit 509, in these examples, provides for communications with other data processing systems or devices. In these examples, communications unit 509 is a network interface card. Communications unit 509 may provide communications through the use of either or both physical and wireless communications links.

Input/output (I/O) unit 511 allows for input and output of data with other devices 105 that may be connected to data processing system 500. For example, input/output (I/O) unit 511 may provide a connection for user input through a keyboard, a mouse, and/or some other suitable input device. Further, input/output (I/O) unit 511 may send output to a printer. Display 513 provides a mechanism to display information to a user.

Instructions for the operating system, applications, and/or programs may be located in storage devices 515, which are in communication with processor unit 503 through communications fabric 501. In these illustrative examples, the instructions are in a functional form on persistent storage 507. These instructions may be loaded into memory 505 for execution by processor unit 503. The processes of the different embodiments may be performed by processor unit 503 using computer implemented instructions, which may be located in a memory, such as memory 505.

These instructions are referred to as program code 517, computer usable program code, or computer readable program code that may be read and executed by a processor in processor unit 503. The program code 517 in the different embodiments may be embodied on different physical or computer readable storage media 519, such as memory 505 or persistent storage 507.

Program code 517 is located in a functional form on computer readable storage media 519 that is selectively removable and may be loaded onto or transferred to data processing system 500 for execution by processor unit 503. Program code 517 and computer readable storage media 519 form computer program product 523 in these examples. In one example, computer readable storage media 519 may be computer readable storage media 519 or computer readable signal media 521. Computer readable storage media 519 may include, for example, an optical or magnetic disk that is inserted or placed into a drive or other device 105 that is part of persistent storage 507 for transfer onto a storage device, such as a hard drive, that is part of persistent storage 507. Computer readable storage media 519 also may take the form of a persistent storage, such as a hard drive, a thumb drive, or a flash memory, that is connected to data processing system 500. In some instances, computer readable storage media 519 may not be removable from data processing system 500.

Alternatively, program code 517 may be transferred to data processing system 500 using computer readable signal media 521. Computer readable signal media 521 may be, for example, a propagated data signal containing program code 517. For example, computer readable signal media 521 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 517 may be downloaded over a network to persistent storage 507 from another device 105 or data processing system 500 through computer readable signal media 521 for use within data processing system 500. For instance, program code stored in a computer readable storage medium in a server data processing system may be downloaded over a network from the server to data processing system 500. The data processing system 500 providing program code 517 may be a server computer, a client computer, or some other device capable of storing and transmitting program code 517.

The different components illustrated for data processing system 500 are not meant to provide architectural limitations to the manner in which different embodiments may be implemented. The different illustrative embodiments may be implemented in a data processing system 500 including components in addition to or in place of those illustrated for data processing system 500. Other components shown in FIG. 5 can be varied from the illustrative examples shown. The different embodiments may be implemented using any hardware device or system capable of running program code 517. As one example, the data processing system 500 may include organic components integrated with inorganic components and/or may be comprised entirely of organic components excluding a human being. For example, a storage device may be comprised of an organic semiconductor.

In another illustrative example, processor unit 503 may take the form of a hardware unit that has circuits that are manufactured or configured for a particular use. This type of hardware may perform operations without needing program code 517 to be loaded into a memory from a storage device to be configured to perform the operations.

For example, when processor unit 503 takes the form of a hardware unit, processor unit 503 may be a circuit system, an application specific integrated circuit (ASIC), a programmable logic device, or some other suitable type of hardware configured to perform a number of operations. With a programmable logic device, the device 105 is configured to perform the number of operations. The device 105 may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 517 may be omitted because the processes for the different embodiments are implemented in a hardware unit.

In still another illustrative example, processor unit 503 may be implemented using a combination of processors found in computers and hardware units. Processor unit 503 may have a number of hardware units and a number of processors that are configured to run program code 517. With this depicted example, some of the processes may be implemented in the number of hardware units, while other processes may be implemented in the number of processors.

The different illustrative embodiments can take the form of an entirely hardware embodiment, an entirely software embodiment, or an embodiment containing both hardware and software elements. Some embodiments are implemented in software, which includes but is not limited to forms such as, for example, firmware, resident software, and microcode.

Furthermore, the different embodiments can take the form of a computer program product accessible from a computer usable or computer readable medium providing program code 517 for use by or in connection with a computer or any device 105 or system that executes instructions. For the purposes of this disclosure, a computer usable or computer readable medium can generally be any tangible apparatus that can contain, store, communicate, propagate, or transport the program for use by or in connection with the instruction execution system, apparatus, or device.

The computer usable or computer readable medium can be, for example, without limitation an electronic, magnetic, optical, electromagnetic, infrared, or semiconductor system, or a propagation medium. Non-limiting examples of a computer readable medium include a semiconductor or solid-state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W), and DVD.

Further, a computer usable or computer readable medium may contain or store a computer readable or computer usable program code 517 such that when the computer readable or computer usable program code is executed on a computer, the execution of this computer readable or computer usable program code causes the computer to transmit another computer readable or computer usable program code over a communications link. This communications link may use a medium that is, for example, without limitation, physical or wireless.

A data processing system 500 suitable for storing and/or executing computer readable or computer usable program code 517 will include one or more processors coupled directly or indirectly to memory elements through a communications fabric, such as a system bus. The memory elements may include local memory employed during actual execution of the program code, bulk storage, and cache memories which provide temporary storage of at least some computer readable or computer usable program code 517 to reduce the number of times code may be retrieved from bulk storage during execution of the code.

Input/output or I/O devices 135 can be coupled to the system either directly or through intervening I/O controllers. These devices 105 may include, for example, without limitation, keyboards, touch screen displays, and pointing devices. Different communications adapters may also be coupled to the system to enable the data processing system 500 to become coupled to other data processing systems 500 or remote printers or storage devices through intervening private or public networks. Non-limiting examples of modems and network adapters are just a few of the currently available types of communications adapters.

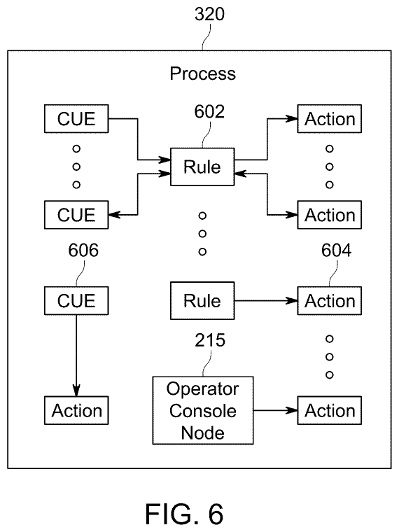

FIG. 6 schematically shows an exemplary embodiment of a sub- or co-process for node 210, operator console node 215. Each sub- or co-process 320 includes one or more actions 604 that can be triggered by one or more rules 602 and/or one or more cues 606 or by a direct command from an operator console node 215. In another embodiment, one or more cues 606 can trigger one or more rules 602 or one or more actions 604 can trigger one or more rules 602. For example, one or more rules 602 can initiate one or more actions 604 in response to one or more cues 606.

In one exemplary embodiment, each rule 602 can be an if-then or an and-or statement or other similar type of case or logic statement. The cues 606 can be associated with the “if” conditions of the rule and can include measured parameters, e.g., velocities, accelerations, positions, voltages, currents, etc., and logic inputs, e.g., “1s” or “0s,” from other nodes or devices. The actions 604 can be associated with the “then” portion of the rule and can include controlling an operating speed of the machine(s) associated with the node or device, sending messages or commands to other nodes or devices, changing operational status, e.g., on or off, of system components, e.g., lights, relays or switches.

In one exemplary embodiment, an axis process can be a software algorithm executed on the microprocessor of a corresponding node to generate instructions to move a motor on a winch to wind or reel. For example, if an instruction is given to move a theatrical object at the end of a cable of a winch a total of 30 feet at 4 feet per second and then stop, the axis process can perform all of the calculations required to generate the voltages and currents necessary for the motor to accomplish the desired cable movement.

FIG. 7 shows an example of an automation and control system 100 according to the present disclosure. In the embodiment shown in FIG. 7, a theatrical object 701 is suspended by suspension lines 705 from winches 703. In the embodiment shown, theatrical object 701 is a flying performer that is moved by drawing up and deploying suspension lines 705. While FIG. 7 shows an example wherein the theatrical object 701 is a flying performer, the disclosure is not so limited. Other suitable theatrical objects 701 include scenery components, cameras, equipment, or other objects to which motion is advantageous. The suspension lines 705 may be any wires, ropes, lines or other elongated supports that is capable of providing support and providing motion to theatrical object 701.

Winches 703 are devices 105, as described above with respect to automation and control system 100. Theatrical object 701 in this embodiment includes a sensor 325 to sense conditions in the environment and/or positions of theatrical object 701. For example, sensor 325 may be a position sensor or encoder to provide automation and control system 100 with position information about theatrical object 701. However, the disclosure is not so limited and the theatrical object 701 may include or may not include sensor 325. Each winch 703 includes an axis node 210 to provide control to each winch 703. Each axis node 210 on theatrical object 701 and winch 703 is in communication with operator console 115 by control line 709. Control line 709 may be a wired or wireless connection. Control line 709 connects to operator console node 215 of operator console 115. The operator console node 215 includes a sunstone tool 409 space device 407 and a node process 317. The sunstone tool 407 is in communication with the space device 407 and node process 317. The sunstone tool 409 and the space device 407 provide a node process 317, which may include a live motion path, which is communicated via control line 709 to each node of each device 105 in order to provide motion control. A manual control device 707 such as a joystick is included with operator console 115 and in communication with operator console node 215 and display 513.

Display 513 includes a first operator interface 411 and a second operator interphase 413. While the first operator interface 411 and second operator interface 413 are shown as a portion of display 513, the disclosure is not so limited and may include a first operator interface 411 and second operator interface 413 be separate from display 513. In addition, display 513 may display potential motion paths for the operator to monitor and/or select. For example, display 513 may display a first motion path 801 generated by space device 407. This first motion path 801 may be a pre-programmed motion path or a motion path input modified by the operator via the space device 407. Sunstone tool 409 not only provides an optimized flight path selection that may be a manual or automatic selection to the user, but also an operational cloud zone in 3D space for the payload being flown. This cloud zone can give a visual indication to the operator of many things, not limited to the current overtravel envelopes of the payload or permissible changes in speed in other payload directions in the path of the motion. The adjusted second motion path 901 may be a motion path calculated or defined by the sunstone tool 407 in response to the first motion path 801 and one or more object movement parameters. While not so limited, the object movement parameters may include one or more of position of the theatrical object 701, velocity of the theatrical object 701, acceleration of the theatrical object 701, cable tension, g-forces of the theatrical object 701, jerk of the theatrical object 701, floating counterweights, boundary condition stiffness, venue dimensions, position of obstacles and combinations thereof. The calculation, as discussed above, results in the adjusted second motion path and is displayed on display 513. Likewise, manual control device 707 may be included as either or both of first operator interface 411 and second operator interface 413. A sensor 325 may be provided to provide or sense any conditions within the system and may provide this information to operator console node 215. A live motion path is selected from the first motion path 801, the adjusted second motion path 901 and combinations thereof. The selection of the live motion path 711 may be made either by manual operation of the operator via second operator interface 413 or the second operator interface 413 may be a control signal automatically selected via a preprogrammed or reactive code or instructions. For example, the live motion path 711 may be selected based upon a collision or other safety consideration that is determined by the calculations made by the sunstone tool 409.

Once the live motion path 711 is selected, the live motion path 711 is processed for the theatrical object 701 and a relationship is determined between the theatrical object 701 and the plurality of devices 105 to generate one or more control instructions to control operation of the devices 105 to move the theatrical object 701 along the live motion path 711. Once the live motion path 711 is processed, motion is provided to the theatrical objects 701 by providing control and motion to devices 105. In particular, as shown in FIG. 7, devices 105 are winches 703 and the winches 703 are cooperatively controlled to provide live motion path 711 for theatrical object 701.

While the above description has discussed the movement of a single theatrical object 701 in the predefined space, it is to be understood that the space device 407 and sunstone tool 409 can be used to simulate and implement the movement of multiple theatrical objects 701 in the predefined space. Each theatrical object 701 in the predefined space can have its own motion profile that governs its movements in the predefined space. In one embodiment, an object's motion profile can be defined relative to the predefined space, but in another embodiment, an object's motion profile, as well as position and orientation, can be defined relative to another object. If the theatrical object's motion profile is defined relative to another object, the motion profile can be to converted to a motion profile defined relative to the predefined space.

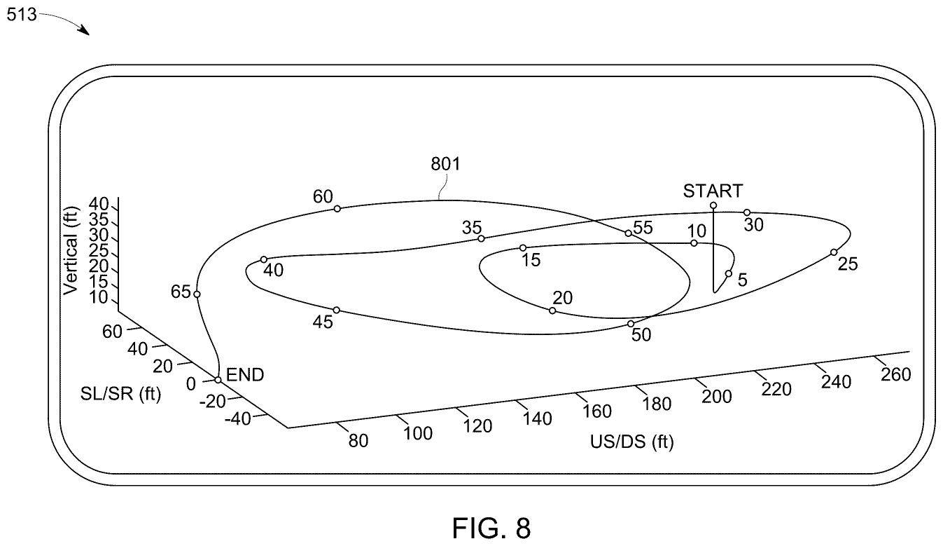

FIG. 8 shows a first motion path 801 of a theatrical object 701 generated by a space device 407 shown on a display 513 according to an embodiment of the present disclosure. The motion path 801, for example, includes a three-dimensional flight path, including times in seconds for the predicted position of the theatrical object 701. The first motion path 801 may be preprogrammed, manually inputted by the operator or may be a modified motion path, with the modification made by the operator. In this figure obstacles, the rigging locations for the cables or members that support the payload and other flown payloads can be shown.

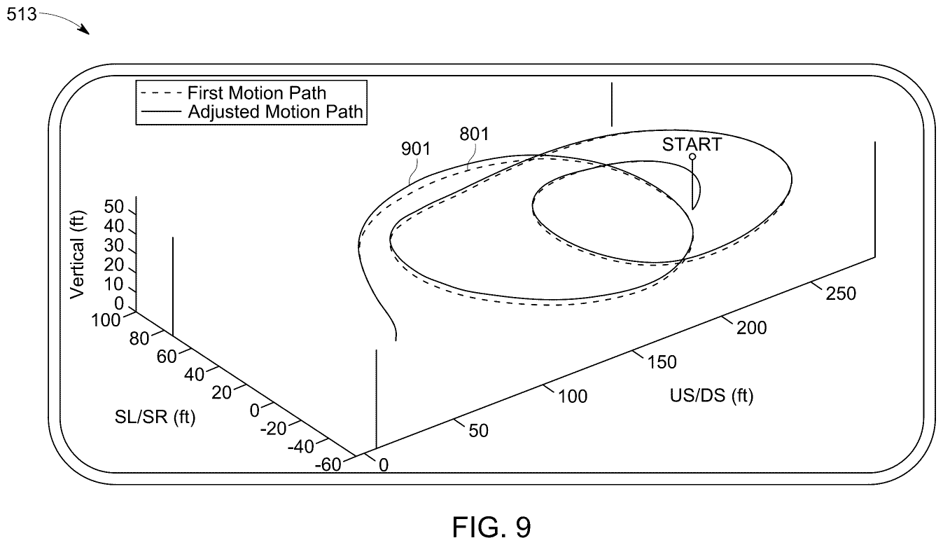

FIG. 9 shows an example of a first motion path 801 generated by a space device 407 and an adjusted second motion path 901 generated by a sunstone tool 409 shown on a display 513 according to an embodiment of the present disclosure. The first motion path 801 and the adjusted second motion path 901 are shown to the operator so that the operator may make adjustments to the live motion path 711. The live motion path 711 (see for example, FIG. 7) may be the first motion path 801, the adjusted second motion path 901 or may be a combination of both the first motion path 801 and the adjusted second motion path 901. The selection of the live motion path 711 may be made by the operator manually, or may be automatically selected via a preprogrammed or reactive code or instructions. The adjusted second motion path 901 may not only differ in its location in physical space, but also the payload's allowable velocity, acceleration and jerk along the second adjusted motion path 901.

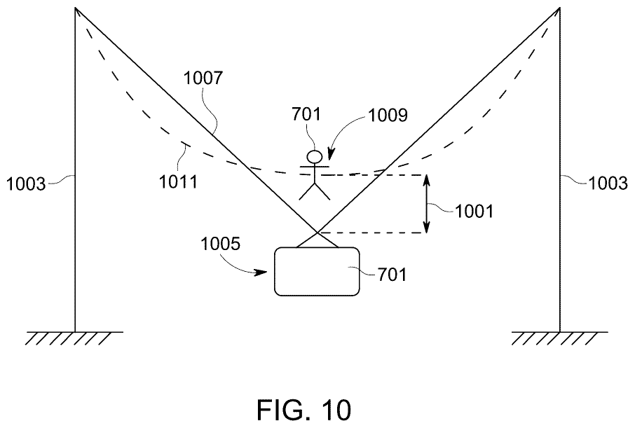

FIG. 10 shows an example of a position error 1001 generated by the sunstone tool 409 according to an embodiment of the present disclosure. More specifically, FIG. 10 shows an example of the position error 1001 of a theatrical object 701 suspended from towers 1003 that occurs due to cable catenary effects. The sunstone tool 409 utilizes one or more object movement parameters to calculate a position error 1001 and corrects the position and/or motion path for the theatrical object 701 by showing an adjusted position for the theatrical object 701. As shown in FIG. 10, the theatrical object 701 is shown in two positions: 1) a first position 1005 suspended by an initial suspension line 1007 and a second position 1009 suspended by an adjusted suspension line 1011. The first motion path 801, as shown and described above for example in FIG. 8, does not include a motion path or position that takes into account catenary effects due to the self-weight of the cable. Catenary effects are object movement parameters that are non-linear and a non-trivial mathematical problem and provide significant advantage in providing accurate positioning of a theatrical object 701, such as a flying performer, during a live entertainment event.

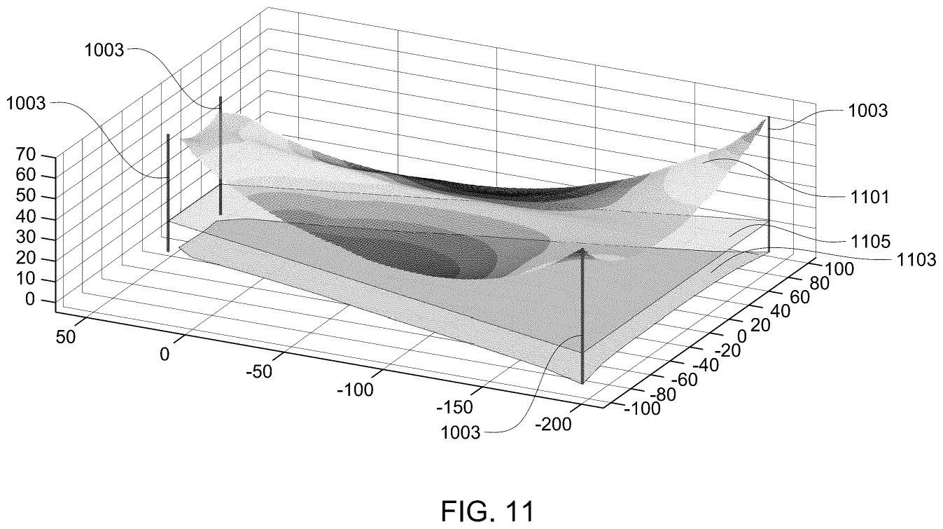

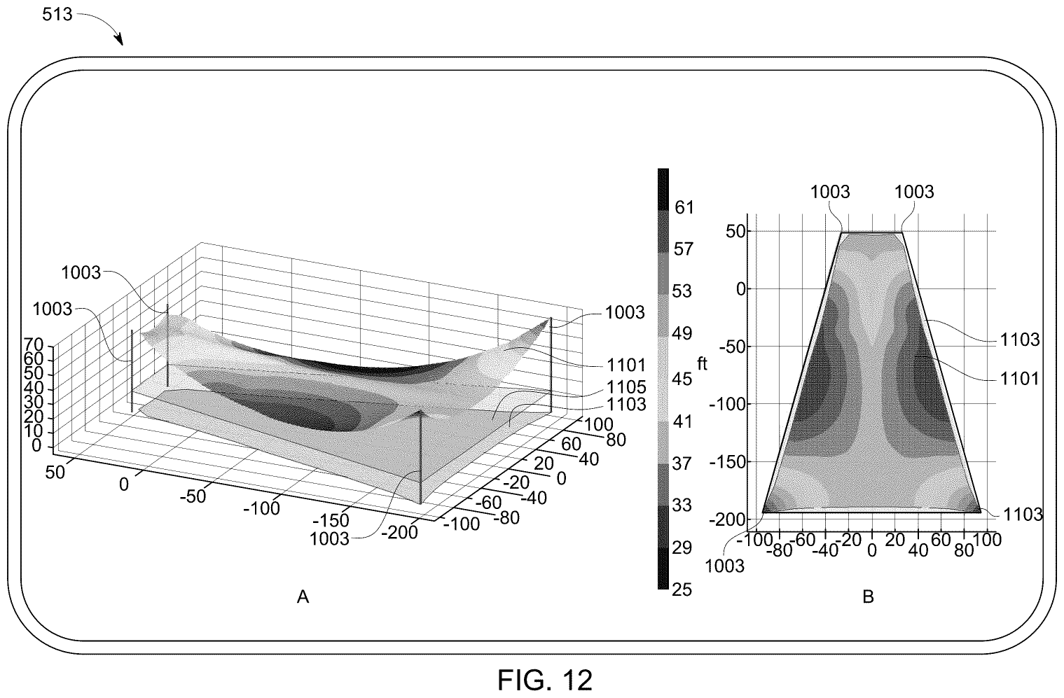

FIG. 11 shows another feature of the sunstone tool 409 according to an embodiment of the present disclosure. As shown in FIG. 11, display 513 shows a graph illustrating a cloud zone 1101 for a theatrical object 701, such as a flying performer, generated by the sunstone tool 409 according to an embodiment of the present disclosure. The cloud zone 1101, shown as a multi-shaded 3D surface, created by the sunstone tool 409 for the maximum height attainable by the payload, such as theatrical object 701, within the possible flight zone 1103 (here shown as the lower most surface at the level of the ground) spanned between the rigged locations (here shown by the vertical towers 1003). There is also a second boundary 1105 for the payload that may never be crossed which may be, for example, be in this case is set at a set height, which may be, for example 15 feet, or other standard height restriction in arenas and stadiums. The upper cloud zone 1101 when viewed as a vertical limit for the payload is often referred to as a flight envelope. FIG. 12 show a perspective view (“A”) and a top view (“B”) of the graph of FIG. 11. FIG. 12 illustrates cloud zone 1101 for a theatrical object 701, such as a flying performer, generated by sunstone tool 409 shown on a display 513 according to an embodiment of the present disclosure. As shown in FIG. 12, the flight path of the theatrical object 701, as calculated by the sunstone tool 409, cannot reach the edges of the flight zone due to the object movement parameters of catenary effects and self-weight of the cables.

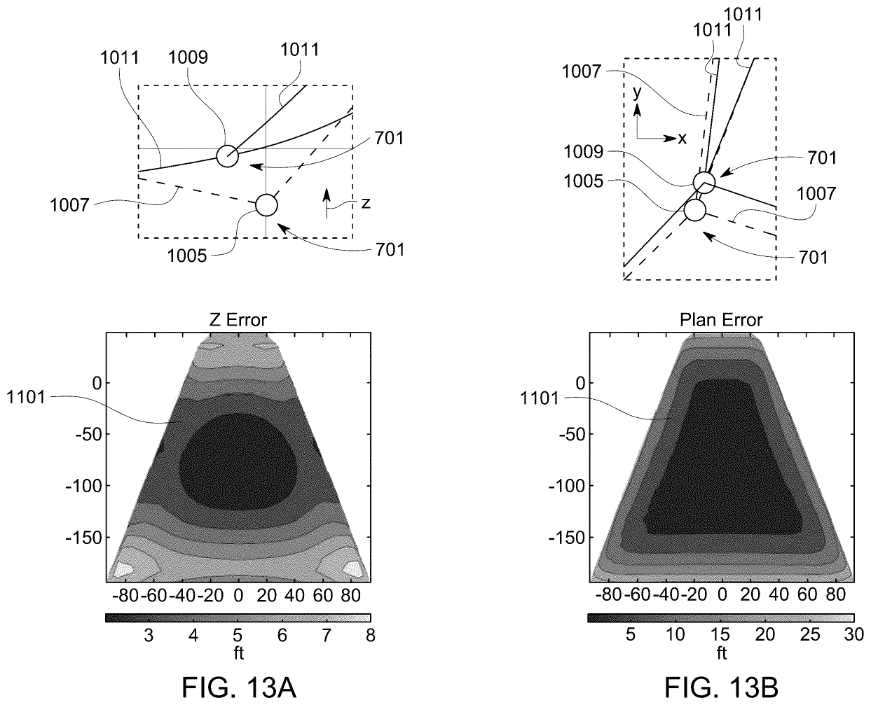

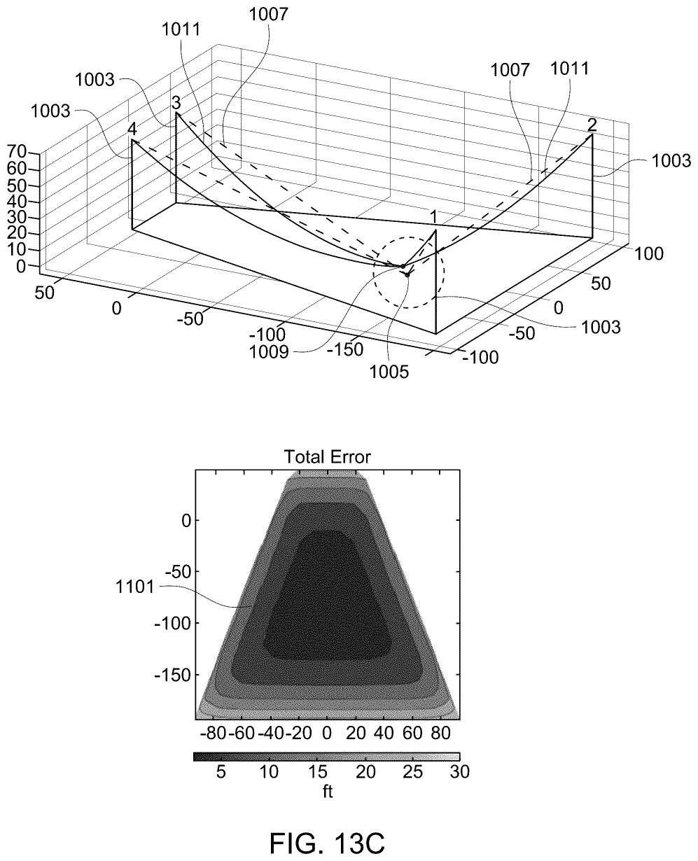

FIGS. 13A, 13B and 13C show position errors in the motion path for a flying performer generated by sunstone tool 409 shown on a display 513 according to an embodiment of the present disclosure. FIGS. 13A, 13B and 13C show the operator the position error on a cloud zone 1101 for the motion path of a theatrical object 701 that will occur within the entire possible flight zone. As shown in FIGS. 13A, 13B and 13C show various error calculations from the sunstone tool 409 for the theatrical object 701. As shown, theatrical object 701 is shown in two positions: 1) a first position 1005 suspended by an initial suspension line 1007 and 2) a second position 1009 suspended by an adjusted suspension line 1011. The operator may utilize these displayed cloud zones 1101 and adjusted positions to provide a safe and/or efficient flight path for the theatrical object 701.

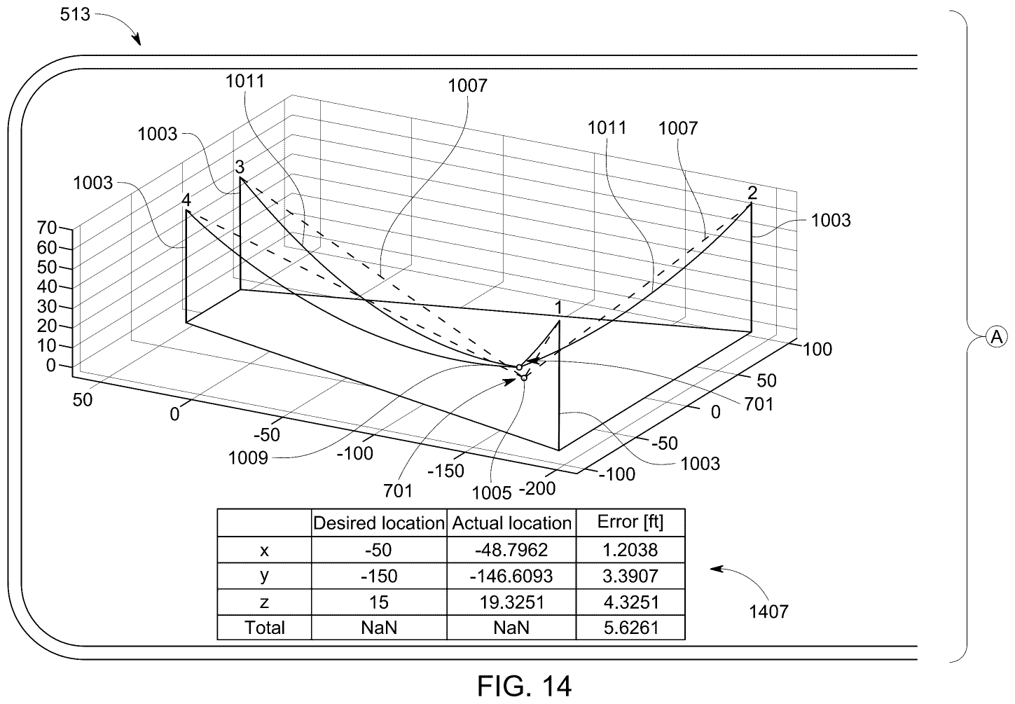

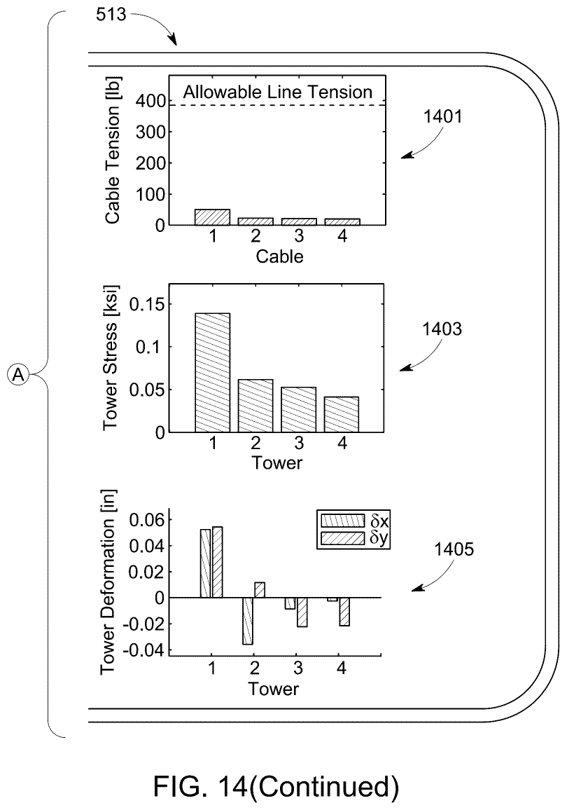

FIG. 14 shows a series of graphs illustrating the positioning of a performer on a motion path generated by a sunstone tool 409 shown on a display 513 showing a first position 1005 corresponding to a first motion path 801 and a second position 1009 corresponding to an adjusted second motion path 901 according to an embodiment of the present disclosure. FIG. 14 shows a solution generated by the sunstone tool 409 as shown by adjusted suspension line 1011 and second position 1009, as displayed and shown to the operator on display 513. Here it is assumed that towers 1003 (shown as vertical lines) are used to provide support to cables that attach to the payload. In addition, display 513 may include graphical representations of line tension, as well as a limit for the maximum allowable line tension (chart 1401), stresses within the towers used to rig the payload (chart 1403), and tower deformation (chart 1405) as calculated by sunstone tool 409. In addition, the display 513 includes positioning of the theatrical object 701 (chart 1407) illustrating the relative positioning of theatrical object 701.

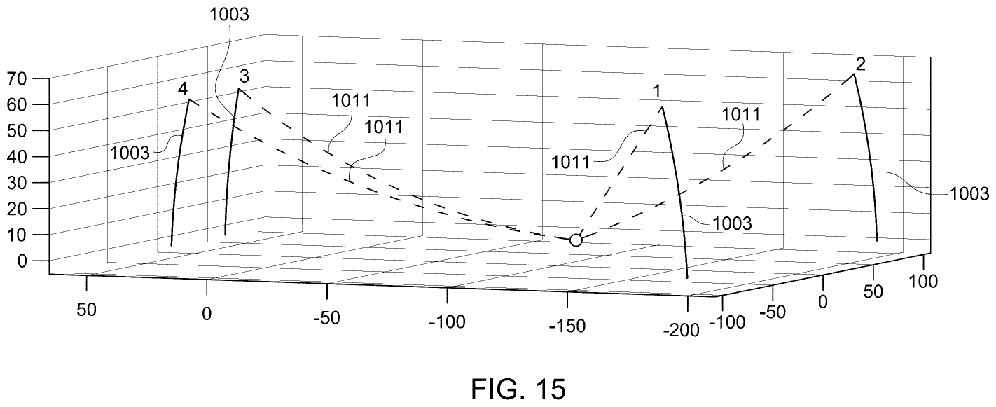

FIG. 15 shows an alternate embodiment including a graph illustrating flexible towers 1003 that provide deformation conditions that are object movement parameters utilized by the sunstone tool 409 according to an embodiment of the present disclosure. FIG. 15 shows a solution from sunstone tool 409 that shows how the boundary condition stiffness can be included as the object movement parameter in the solution and simulation and calculation of the second position of the theatrical object 701. As shown in FIG. 15, the towers 1003 can be flexible and bent (for instance thin steel poles or carbon fiber). These deformations from the boundary conditions are a unique additional object movement parameter that can be included in the sunstone tool 409.

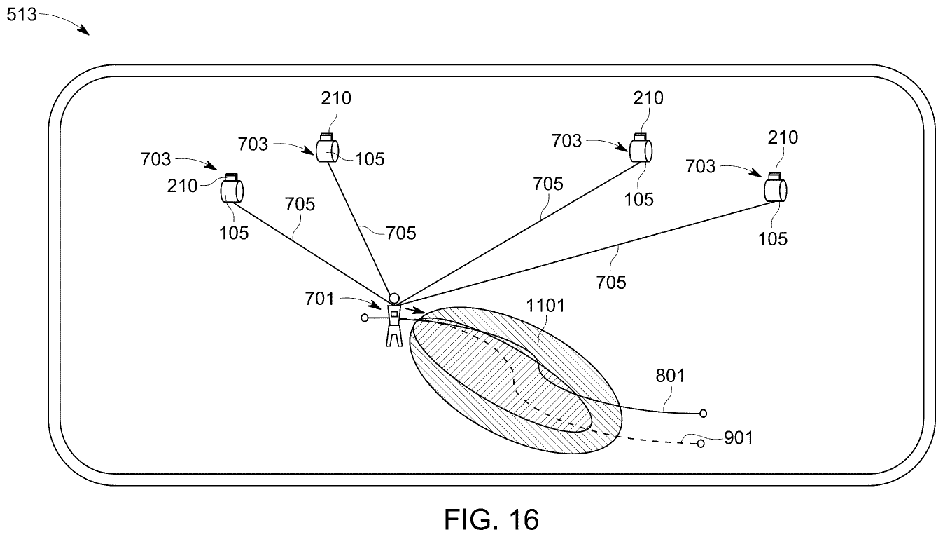

FIG. 16 shows another exemplary display 513 shown to an operator by the sunstone tool 409 showing a first motion path 801 and an adjusted second motion path 901 including a cloud zone 1101 generated with the sunstone tool 409 according to an embodiment of the present disclosure. FIG. 16 shows an example of an output from the sunstone tool 409 showing the operator a desirable, safe or optimum flight envelope during the flight path within the cloud zone 1101. The adjusted second flight path 901 is shown as being within the cloud zone 1101, while the first motion path 801 deviates from the optimum flight envelope shown by the cloud zone 1101. As shown in FIG. 16, the cloud zone 1101 indicates the current overtravel envelope on the flown payload that may occur in the event of a failure, therefore this cloud zone 1101 should never overlap with any obstacles. The colored portions of the cloud zone 1101 indicate the relative change in velocity of the payload that will need to occur to maintain flight safety, and where that speed can be maximized. As shown, the adjusted flight path maintains the maximum possible velocity of the payload while bringing it to the center of the possible overtravel envelope, maintaining the safest distance from any possible obstacles.

The present application contemplates methods, systems and program products on any machine-readable media for accomplishing its operations. The embodiments of the present application may be implemented using an existing computer processor, or by a special purpose computer processor for an appropriate system, or by a hardwired system.

Embodiments within the scope of the present application include program products comprising machine-readable media for carrying or having machine-executable instructions or data structures stored thereon. Machine-readable media can be any available non-transitory media that can be accessed by a general purpose or special purpose computer or other machine with a processor. By way of example, machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Combinations of the above are also included within the scope of machine-readable media. Machine-executable instructions comprise, for example, instructions and data which cause a general-purpose computer, special purpose computer, or special purpose processing machine to perform a certain function or group of functions. Software implementations could be accomplished with standard programming techniques with rule based logic and other logic to accomplish the various connection steps, processing steps, comparison steps and decision steps.

While the exemplary embodiments illustrated in the figures and described herein are presently preferred, it should be understood that these embodiments are offered by way of example only. Other substitutions, modifications, changes and omissions may be made in the design, operating conditions and arrangement of the exemplary embodiments without departing from the scope of the present application. Accordingly, the present application is not limited to a particular embodiment, but extends to various modifications that nevertheless fall within the scope of the appended claims. It should also be understood that the phraseology and terminology employed herein is for the purpose of description only and should not be regarded as limiting.

It is important to note that the construction and arrangement of the present application as shown in the various exemplary embodiments is illustrative only. Only certain features and embodiments of the invention have been shown and described in the application and many modifications and changes may occur to those skilled in the art (e.g., variations in sizes, dimensions, structures, shapes and proportions of the various elements, values of parameters (e.g., temperatures, pressures, etc.), mounting arrangements, use of materials, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A method to control motion of a theatrical object, the method comprising:
providing a plurality of axis nodes and an operator console node in communication with each other over a real time network, each axis node of the plurality of axis nodes corresponds to at least one device for control of motion of a theatrical object, each axis node of the plurality of nodes and the operator console node comprise a microprocessor and a memory device, the operator console node further comprises a sunstone tool and a space device;
defining a first motion path for the theatrical object with a first operator interface of the space device;
providing one or more object movement parameters to the sunstone tool;
defining an adjusted second motion path for the theatrical object with the sunstone tool in response to the one or more object movement parameters and the first motion path;
displaying the first motion path and the adjusted second motion path for the theatrical object with a display device to an operator;
selecting a live motion path from the group consisting of the first motion path, the adjusted second motion path and combinations thereof;
processing the live motion path for the theatrical object and determining the relationship between the theatrical object and the plurality of devices to generate one or more control instructions to control operation of the devices to move the theatrical object along the live motion path; and
providing motion to the devices with the control instructions to move the theatrical object along the live motion path.

2. The method of claim 1, further comprising defining a cloud zone for the adjusted second motion path with the sunstone tool in response to the one or more object movement parameters and the first motion path and displaying the cloud zone with the display device to an operator.

3. The method of claim 1, wherein the first motion path is entered via first operator interface as a preprogrammed motion path, a path generated manually from a joystick or a path inputted from a manual control mechanism to the space device.

4. The method of claim 1, wherein the adjusted second motion path is entered via a second operator interface as a preprogrammed motion path, a path generated manually from a joystick or a path inputting from a manual control mechanism to the sunstone tool.

5. The method of claim 1, wherein selecting a live motion path from the group consisting of the first motion path, the adjusted second motion path and combinations thereof includes manual selection by the operator or automatic selection via a preprogrammed or reactive code or instructions.

6. The automation and control system of claim 1, further comprises one or more sensors for providing the object movement parameter for the theatrical object.

7. The method of claim 6, wherein the sensor provides real-time object movement parameter for the theatrical object to the sunstone tool.

8. The method of claim 1, wherein the object movement parameter is selected from the group consisting of position of the theatrical object, jerk of the theatrical object, velocity of the theatrical object, acceleration of the theatrical object, cable tension, g-forces of the theatrical object, venue dimensions, position of obstacles, floating counterweights, boundary condition stiffness, and combinations thereof.

9. The method of claim 1, wherein the device is a winch, a lift, or a motor.

10. The method of claim 1, wherein the theatrical object is a flying performer.

11. An automation and motion control system to control motion of a theatrical object, the control system comprising:
a plurality of axis nodes and an operator console node in communication with each other over a real time network, the axis node corresponding to a device for control of motion of a theatrical object, the axis node providing control to the device to, in combination with additional axis nodes of the plurality of nodes, provide motion to the theatrical object;
each axis node of the plurality of nodes and the operator console node comprising a microprocessor and a memory device, the operator console node further comprising a sunstone tool and a space device, the space device comprising:
a display device enabled to display a first motion path and an adjusted second motion path for the theatrical object in the predefined space;
a first operator interface enabled to define the first motion path for the theatrical object in the predefined space; and
a second operator interface enabled to select a live motion path from the group consisting of the first motion path, the adjusted second motion path and combinations thereof;
wherein the sunstone tool is in communication with the space device, the sunstone tool being configured to receive one or more object movement parameters and the first motion path to calculate the adjusted second motion path in response to the one or more object movement parameters and the first motion path.

12. The automation and motion control system of claim 11, wherein the display device is further enabled to display a cloud zone for the adjusted second motion path, the cloud zone being generated with the sunstone tool in response to the one or more object movement parameters and the first motion path.

13. The automation and motion control system of claim 11, wherein the sunstone tool is enabled to communicate the adjusted second motion path to the space device to display the first motion path and the adjusted second motion path for the theatrical object and the relationship between the theatrical object and the plurality of devices to at least one axis node of the plurality of axis nodes.

14. The automation and motion control system of claim 11, wherein the second operator interface is enabled to select the live motion path and communicates the live motion path such that the at least one axis node of the plurality of axis nodes processes the live motion path for the theatrical object and the relationship between the theatrical object and the plurality of devices to generate one or more control instructions to control operation of the plurality of devices to move the theatrical object along the live motion path.

15. The automation and motion control system of claim 11, wherein the first motion path is entered via first operator interface as a preprogrammed motion path, a path generated manually from a joystick or a path inputted from a manual control mechanism to the space device.

16. The automation and motion control system of claim 11, wherein the adjusted second motion path is entered via the second operator interface as a preprogrammed motion path, a path generated manually from a joystick or a path inputting from a manual control mechanism to the sunstone tool.

17. The automation and motion control system of claim 11, wherein selecting a live motion path from the group consisting of the first motion path, the adjusted second motion path and combinations thereof includes manual selection by the operator or automatic selection via a preprogrammed or reactive code or instructions.

18. The automation and motion control system of claim 11, wherein the first operator interface is enabled to permit an operator to define the first motion path for the theatrical object in the predefined space.

19. The automation and motion control system of claim 11, further comprises one or more sensors for providing the object movement parameter for the theatrical object.

20. The automation and motion control system of claim 19, wherein the sensor provides real-time object movement parameter for the theatrical object to the sunstone tool.

21. The automation and motion control system of claim 11, wherein the object movement parameter is selected from the group consisting of position of the theatrical object, velocity of the theatrical object, acceleration of the theatrical object, jerk of the theatrical object, cable tension, g-forces of the theatrical object, venue dimensions, position of obstacles, floating counterweights, boundary condition stiffness, and combinations thereof.

22. The automation and motion control system of claim 11, wherein the device is a winch, a lift, or a motor.

23. The automation and motion control system of claim 11, wherein the theatrical object is a flying performer.
